(19) United States
(12) Patent Application Publication
(10) Pub. No.: US 2018/0276576 A1
(43) Pub. Date: Sep. 27, 2018

(54) Hardware and Software System for Swapping Appointment Between Customers

(71) Applicant: Live Chair, Inc., Washington, DC (US)

(72) Inventors: Peter Blair, Clemson, SC (US); Michael DeVore, Varnville, SC (US); Jeffrey Mund, Washington, DC (US); Jahmal Rhaney, Philadelphia, PA (US); Andrew Suggs, Philadelphia, PA (US)

(73) Assignee: Live Chair, Inc., Washington, DC (US)

(21) Appl. No.: 15/933,397

(22) Filed: Mar. 23, 2018

Related U.S. Application Data
(60) Provisional application No. 62/475,303, filed on Mar. 23, 2017.

(51) Int. Cl. G06Q 10/02; G06Q 20/10; G06Q 20/22

(52) U.S. Cl. CPC G06Q 10/02; G06Q 20/223; G06Q 20/10

(57) ABSTRACT

Methods and systems may be used to allow a first customer to book an appointment. A second customer may view the appointment and initiate a request to swap for the reserved appointment. The first customer may accept or reject the offer. If the offer is accepted, the appointment may be transferred from the first customer to the second customer. A computer application may facilitate the transfer of payment from the second customer to any or all of: the customer holding the appointment, the service provider for whom the appointment was made, and the provider of the computer application.

### CROSS-REFERENCE TO RELATED APPLICATIONS

This application claims the benefit of U.S. Provisional Patent Application No. 62/475,303, filed Mar. 23, 2017, which is hereby incorporated by reference in its entirety.

### FIELD OF THE INVENTION

The present invention relates generally to swapping an appointment with a service provider between customers.

### BACKGROUND

In some circumstances, a customer may wish to make an appointment with a service provider, but may find that the service provider is already booked for that time. Present systems lack an ability for a customer to be able to obtain the already booked reservation from another customer by performing a swap, optionally by paying a fee.

It would be desirable to provide a method and a hardware and software system for securely facilitating the transfer of an appointment from one customer to another. One advantage of the system would be enabling the transfer of an appointment from a customer who values the appointment less to another customer who values the appointment more.

### SUMMARY OF THE INVENTION

In an exemplary embodiment, a computer application allows customers to book appointments with one or more service providers. When an appointment time is booked, the computer application may display the time as reserved. A customer viewing a reserved appointment time may initiate an action to make an offer to perform a swap for the reserved appointment. A customer holding the reserved appointment time may accept or reject the offer of a swap. If the customer holding the reserved appointment accepts, then the computer application may transfer the appointment from the customer holding the appointment to the customer requesting the swap. The computer application may accept payment from the second customer to perform the swap. The computer application may facilitate the transfer of payment from the second customer to any or all of: the customer holding the appointment, the service provider for whom the appointment was made, and the provider of the computer application.

### BRIEF DESCRIPTION OF THE DRAWINGS

FIG. 1 illustrates an exemplary method for swapping an appointment between customers.

FIG. 2 illustrates an exemplary hardware and software architecture of an embodiment.

FIG. 3 illustrates a flow chart of an exemplary method for swapping an appointment between customers.

FIG. 4 illustrates a flow chart of an exemplary method for swapping an appointment between customers.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment. Further, some steps may be performed in part by one component in a network and other parts of the step may be performed by other components on the network. All method steps should be considered optional unless explicitly stated otherwise.

Embodiments of the invention may comprise one or more computers. Embodiments of the invention may comprise software and/or hardware. Some embodiments of the invention may be software only and may reside on hardware. A computer may be special-purpose or general purpose. A computer or computer system includes without limitation personal computers, desktop computers, laptop computers, mobile devices, cellular phones, smart phones, PDAs, pagers, multi-processor-based devices, microprocessor-based devices, programmable consumer electronics, tablets, minicomputers, mainframe computers, server computers, microcontroller-based devices, DSP-based devices, embedded computers, wearable computers, electronic glasses, computerized watches, devices performing computations on a processor or CPU, and the like. The term “computer” or “computer system” further includes distributed systems, which are systems of multiple computers (of any of the aforementioned kinds) that interact with each other, optionally over a network. Distributed systems may include clusters, grids, shared memory systems, message passing systems, and so forth. Thus, embodiments of the invention may be practiced in distributed environments involving local and remote computer systems. In a distributed system, aspects of the invention may reside on multiple computer systems.

Embodiments of the invention may comprise computer-readable media having computer-executable instructions or data stored thereon. A computer-readable media is physical media that can be accessed by a computer. It may be non-transitory. Examples of computer-readable media include, but are not limited to, RAM, ROM, hard disks, flash memory, DVDs, CDs, magnetic tape, and floppy disks.

Computer-executable instructions comprise, for example, instructions which cause a computer to perform a function or group of functions. Some instructions may include data. Computer executable instructions may be binaries, object code, intermediate format instructions such as assembly language, source code, byte code, scripts, and the like. Instructions may be stored in memory, where they may be accessed and/or executed by a processor. Memory is storage for instructions and/or data. Memory includes temporary, semi-permanent, and permanent storage.

A computer program is software that comprises multiple computer executable instructions. The term “computer program” includes any sequence of instructions. The term “computer program” includes, for example, a software module. The term “computer program” is not limited to “separate” or “self-contained” computer programs.

Computer systems may have a processor, memory, a display, and peripherals like a keyboard, mouse, a USB port, a wireless communications unit, a network card, a Bluetooth controller, and so forth. The memory of a computer system may store instructions for execution.

A database is a collection of data and/or computer hardware used to store a collection of data. It includes databases, networks of databases, and other kinds of file storage, such as file systems. No particular kind of database must be used. The term database encompasses many kinds of databases such as hierarchical databases, relational databases, post-relational databases, object databases, graph databases, flat files, spreadsheets, tables, trees, and any other kind of database, collection of data, or storage for a collection of data. The term “database” may also be used to refer to a portion of a database.

A network comprises one or more data links that enable the transport of electronic data. Networks can connect computer systems. The term network includes local area network (LAN), wide area network (WAN), telephone networks, wireless networks, intranets, the Internet, and combinations of networks.

### I. Exemplary Embodiment

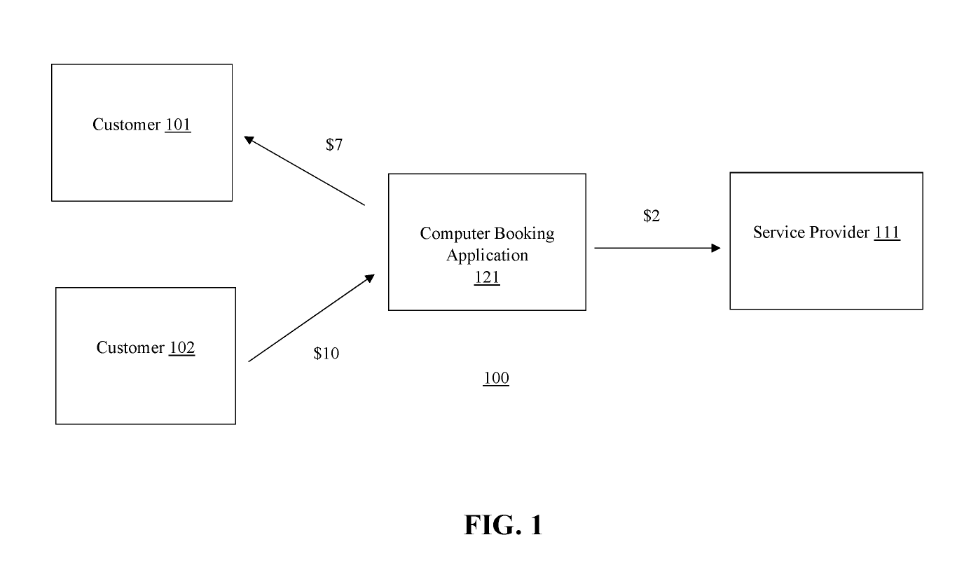

As shown in FIG. 1, in an embodiment 100, one or more customers may make appointments with one or more service providers through a booking computer application. Customers use the booking computer application to schedule an appointment and optionally to pay the service provider. Payments made by a customer through the booking computer application may be stored in the service provider's bank account. In one exemplary embodiment, the service providers are hair cutting professionals and the customers are individuals wanting a haircut. The term “hair cutting professional” includes without limitation barbers and hair stylists, including professionals who cut hair for men, women, and children. By way of example, in an exemplary embodiment, the service providers are barbers who rent barbershop chairs at a barbershop owned by an absentee landlord and serve underserved minority communities.

Although example embodiments herein are described with reference to hair cutting professionals, the methods may be used for swapping appointments for other types of events or services. Methods described herein, including but not limited to methods 300 and 400, may be used for airline passengers to swap seats, for flight attendants to swap flight assignments, for patients to swap appointments with a doctor or dentist at a doctor or dentist office, for tickets or seats to a music event such as a concert, and for tickets or seats to a sporting event.

Service providers may have limited time slots available for appointments. For example, service providers may have limited hours. Service providers may only be open during business hours. In addition, service providers may only be able to serve a limited number of customers at a time. In an embodiment involving hair cutting professionals, a single hair cutting professional may only be able to serve one customer at a time. Therefore, a single appointment time with the hair cutting professional is only suitable for one customer, and once that time is taken, it cannot be used by another customer. In other embodiments, a service provider may be able to serve multiple customers. For example, a service provider may be a restaurant and customers may make appointments to have a meal, such as a reservation. The service provider may be able to serve more than one customer at a time but may have a limit on the number of customers it can take at a time. For a restaurant, the limit may be determined by the number of tables available.

In embodiment 100, customer 101 has booked an appointment at a set time, such as an appointment with a service provider 111, through booking computer application 121. In this case, the service provider 111 is a hair cutting professional. The booking computer application 121 has a stored record of the appointment. The stored record of the appointment may include the set time of the appointment in the form of a time and a date.

Customer 102 wishes to obtain the appointment at the set time from customer 101. For example, customer 102 may be constrained in the times he is available and may need to obtain a hair-cut on short notice. Therefore, customer 102 may value the appointment reserved by customer 101 more than customer 101 does. Customer 102 may send a message to customer 101 requesting to perform a swap, in which customer 102 would obtain the appointment by paying customer 101.

The payment made by customer 102 may be split among several parties. First, part of the payment may be delivered to customer 101. Second, another portion of the payment may be delivered to the service provider 111 for whom the appointment was made. This payment may act as a bonus for service providers who are in high demand. Third, part of the payment may be delivered to the provider of the booking computer application 121 for providing and facilitating the swap service. In an exemplary method of splitting the payment, customer 102 pays $10. Customer 101 receives $7, the service provider 111 receives $2, and the provider of the customer booking application 121 receives $1.

### II. Exemplary Hardware and Software Architecture

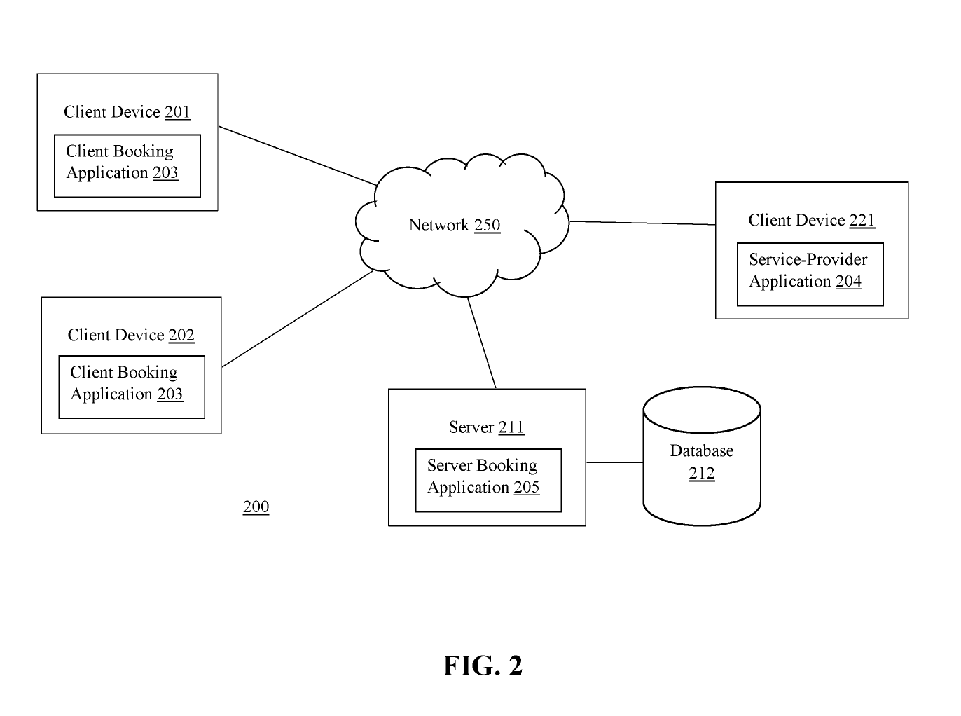

FIG. 2 illustrates an exemplary hardware and software architecture of an embodiment of the system. In network environment 200, a network 250 may connect multiple client devices 201, 202, 221 to one or more servers 211. Network 250 may include a local area network (LAN), a wide area network (WAN), a telephone network, such as the Public Switched Telephone Network (PSTN), an intranet, the Internet, or a combination of networks. Three client devices and one server 211 have been illustrated for simplicity, though in practice there may be more or fewer clients and servers. Server 211 may be implemented as multiple networked server devices, though it is illustrated as a single entity.

In an embodiment, client devices 201, 202, 221 are mobile devices, desktop computers, or tablets and the server 211 is a computer server.

In an embodiment, a client booking application 203 on client devices 201, 202 exchanges electronic communications with server booking application 205. A user of a client device uses the client booking application 203 to view available appointments with service providers and select a desired appointment. The client booking application may obtain the list of available and unavailable appointments from the server booking application 205 and display the appointments to the user. In response to a user selecting a desired appointment in the client booking application 203, the client booking application 203 may transmit an electronic message to the server booking application 205 to cause the server booking application to store the user's reservation of the appointment in a database 212. The server booking application 205 may also confirm to the client booking application 203 that the appointment was successfully made. After reservation, the server booking application 205 may indicate to the client booking application 203 on one or more client devices that the appointment is no longer available.

A service provider may use service-provider application 204 on client device 221. In one embodiment, the service-provider application 204 is the same as, or a module of, client booking application 203. However, service-provider application 204 may also be a different program than client booking application 203. A service provider may use service-provider application 204 to enter available appointment times and view what appointment times have been selected by users. In response to a service provider entering available appointment times in the service-provider application 204, the service-provider application 204 may transmit an electronic message to the server booking application 205 to cause the server booking application 205 to store the service provider's available appointment times in the database 212. Moreover, the service-provider application 204 may obtain the list of available and unavailable appointments from the server booking application 205 and display the appointments to the service provider.

In an embodiment, computer booking application 121 provided by the booking application provider comprises the client booking program 203, service-provider program 204, and server booking program 205.

### III. Exemplary Method

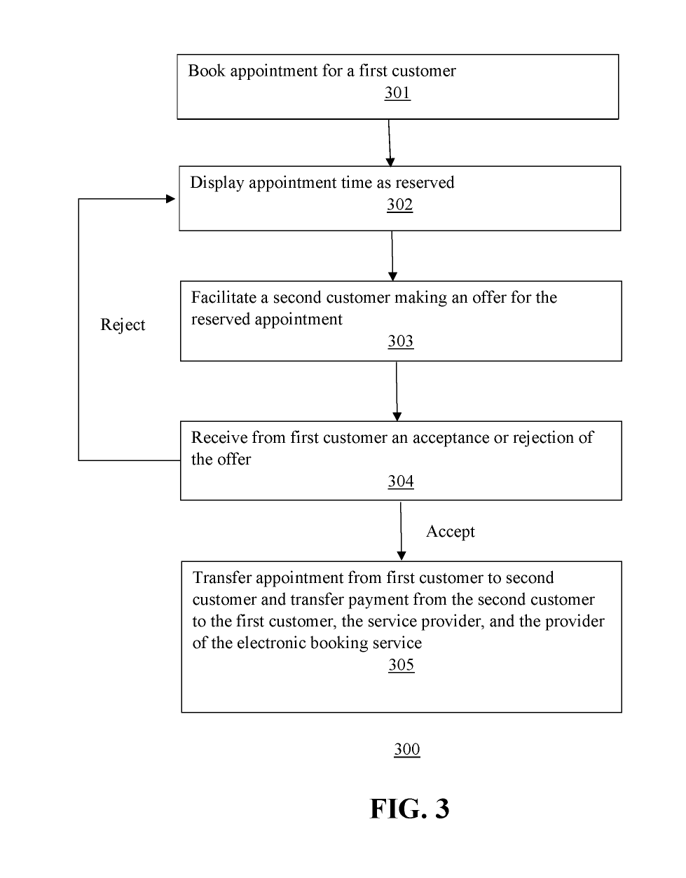

FIG. 3 illustrates an exemplary method 300 that may be used in some embodiments. In step 301, client booking application 203 displays available appointments for service providers. On device 201, a first customer performs actions in client booking application 203 to reserve an appointment for a service provider at a set time. On device 201, the client booking application 203 receives the request for an appointment from the first customer, and, in response, the client booking application 203 exchanges communications with the server booking application 205 to store an appointment for the first customer with the service provider at the requested time.

In step 302, on devices 201, 202, client booking application 203 displays to users that the appointment time reserved by the first customer is reserved.

In step 303, a second customer views the reserved appointment made by the first customer and wishes to obtain the appointment. The second customer performs actions in client booking application 203 to request a swap. On device 202, the client booking application 203 receives the request for swap from the second customer. The client booking application 203 may receive entry of a message from the second customer to be sent with the request for the swap. The client booking application 203 may also receive an offer amount from the second customer indicating the amount that the second customer would be willing to pay to perform the swap and thereby obtain the appointment. Alternatively, the client booking application may provide a fixed amount as the offer amount for performing a swap. The client booking application 203 exchanges communications with the server booking application 205 to transmit the request for swap, including an optional message and offer amount, from the second customer to the first customer. Alternatively, the client booking application 203 may send a message peer-to-peer from device 202 to device 201 to request the swap.

In response to the communications, the client booking application 203 displays a message to the first customer on device 201 indicating the second customer's request for a swap. The client booking application may display a message provided by the second customer and an offer amount. The offer amount shown may be less than that provided by the second customer to account for portions of the funds that will be provided to the service provider and the provider of the booking computer application.

In step 304, the first customer may accept or reject the offer to perform the swap. On device 201, the client booking application 203 may receive input from the first customer indicating acceptance or rejection of the offer. If the client booking application receives an indication of rejection, the client booking application 203 on device 201 may send an indication of the rejection to the second customer on device 202 indicating the rejection. The message may be sent via the server 211 or peer-to-peer. The appointment may remain reserved by the first customer.

In step 305, if the client booking application 203 receives an indication of acceptance, then the client booking application 203 may exchange messages with the server booking application 205 to cause the server booking application 205 to transfer the desired appointment from the first customer to the second customer. In an embodiment, the server booking application 205 may change a database record in database 212 to reflect that the appointment is now held by the second customer instead of the first customer. A message may also be displayed to the service provider by service-provider application 204 to indicate that the customer for the appointment has changed from the first customer to the second customer.

As a result of step 305, client booking application 203 may receive payment from the second customer. A first portion of the payment may be delivered to the first customer. A second portion of the payment may be delivered to the service provider for whom the appointment was made. A third portion of the payment may be delivered to the provider of the computer booking application through which the swap was performed. Payments may be received and delivered in electronic form, such as by electronic transfer. In an embodiment, delivery of the funds may be performed by the server booking application 205 on server 211 by connecting to payment networks. For example, the server booking application 205 may use payment services on the Internet to receive and transfer funds.

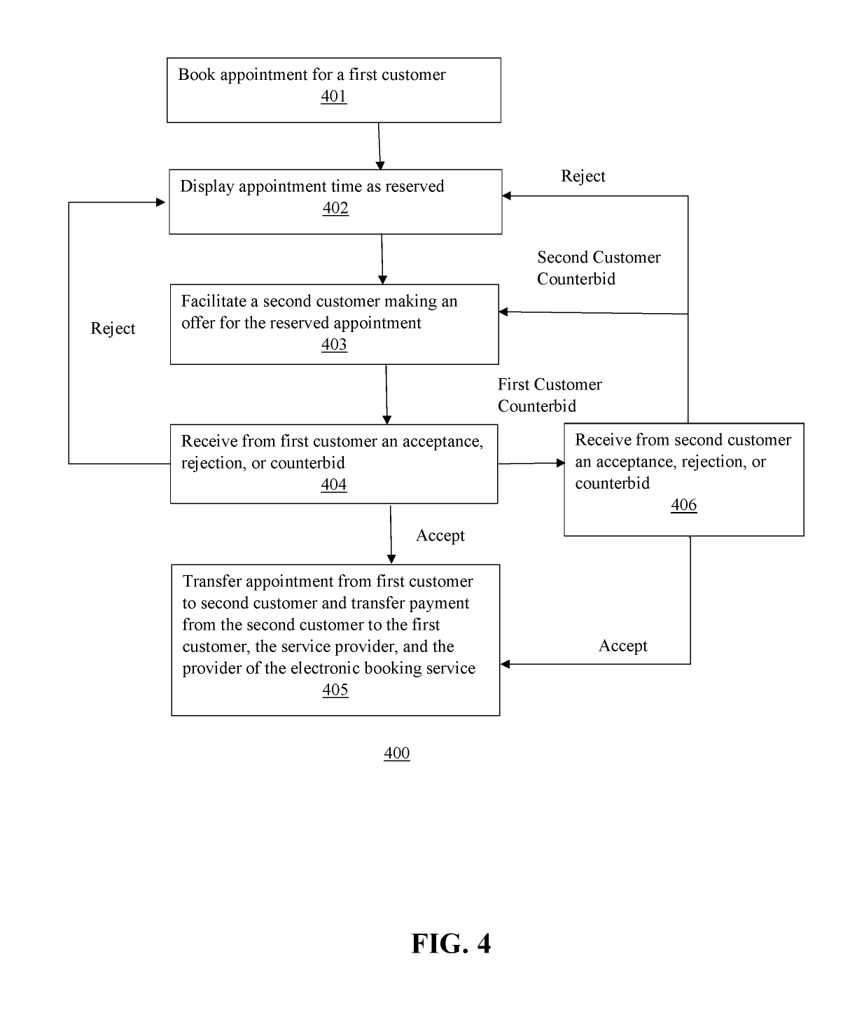

FIG. 4 illustrates an exemplary method 400 that may be used in some embodiments. Steps 401, 402, 403, 404, and 405 are the same as steps 301, 302, 303, 304, and 305 in method 300. However, in step 404, the device 201 presents options for the first customer to accept or reject the offer or counterbid. The device 201 may receive input from the first customer indicating acceptance, rejection, or the counterbid. In response to selection of the first customer of the counterbid option, the device 201 may present a user interface element for the first customer to select a counterbid amount, such as by text entry or selection from a dropdown. The counterbid may then be transmitted from device 201 to the second customer on device 202. Transmission of the counterbid may be made to the server booking application 205 to then transmit the counterbid to the client booking application 203 on device 202. Alternatively, the client booking application 203 may send a message peer-to-peer from device 201 to device 202.

In step 406, the device 202 may present the second customer with the option to accept or reject the counterbid from the first customer or make a counterbid. If the second customer elects to counterbid, the process may proceed to step 403 where the device 202 facilitates the second customer making an offer for the reserved appointment. If the second customer rejects the first customer's counterbid, then an indication of the rejection may be transmitted from device 202 to device 201. The transmission of the rejection may be made to the server booking application 205 to then transmit the rejection to the client booking application 203 on device 201. Alternatively, the client booking application 203 may send a peer-to-peer message from device 202 to device 201.

If the second customer accepts the first customer's counterbid, then an indication of the acceptance may be transmitted from device 202 to device 201. The transmission of the acceptance may be made to the server booking application 205 to then transmit the rejection to the client booking application 203 on device 201. Alternatively, the client booking application 203 may send a peer-to-peer message from device 202 to device 201.

### IV. Exemplary Embodiments

This section lists additional exemplary embodiments. The following embodiments are exemplary only and are non-limiting:
1) A non-transitory computer-readable medium containing instructions for swapping an electronic appointment from a first customer to a second customer, the non-transitory computer-readable medium comprising:
   instructions for booking an appointment between a first customer and a service provider using an electronic booking service;
   instructions for transmitting an electronic offer from a second customer to the first customer to perform a swap of the appointment;
   instructions for, when the first customer accepts the electronic offer, transferring the appointment from the first customer to the second customer;
   instructions for accepting payment from the second customer;
   instructions for transmitting a first portion of the accepted payment from the second customer to the first customer;
   instructions for transmitting a second portion of the accepted payment from the second customer to the service provider;
   instructions for transmitting a third portion of the accepted payment from the second customer to a provider of the electronic booking service.
2) A non-transitory computer-readable medium containing instructions for swapping an electronic appointment from a first customer to a second customer, the non-transitory computer-readable medium comprising:
   instructions for displaying available appointment times for one or more service providers;
   instructions for receiving a request to book an appointment with a service provider;
   instructions for, in response to receiving a request to book an appointment, booking an appointment between a first customer and a first service provider using an electronic booking service;
   instructions for receiving a request from a customer to perform a swap of a currently reserved appointment of a service provider;
   instructions for transmitting an electronic offer from a second customer to the first customer to perform a swap of the appointment of the first customer, the electronic offer including an offer of payment;
   instructions for, when the first customer rejects the electronic offer, not transferring the appointment from the first customer to the second customer;
   instructions for, when the first customer accepts the electronic offer, transferring the appointment from the first customer to the second customer;
   instructions for accepting payment from the second customer;
   instructions for transmitting a first portion of the accepted payment from the second customer to the first customer;
   instructions for transmitting a second portion of the accepted payment from the second customer to the service provider;
   instructions for transmitting a third portion of the accepted payment from the second customer to a provider of the electronic booking service.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects. Rather, the scope of the invention should be determined with reference to patent claims.

We claim:

1) A non-transitory computer-readable medium containing instructions for swapping an electronic appointment from a first customer to a second customer, the non-transitory computer-readable medium comprising:
instructions for booking an appointment between a first customer and a service provider using an electronic booking service;
instructions for transmitting an electronic offer from a second customer to the first customer to perform a swap of the appointment;
instructions for, when the first customer accepts the electronic offer, transferring the appointment from the first customer to the second customer;
instructions for accepting payment from the second customer;
instructions for transmitting a first portion of the accepted payment from the second customer to the first customer;
instructions for transmitting a second portion of the accepted payment from the second customer to the service provider;
instructions for transmitting a third portion of the accepted payment from the second customer to a provider of the electronic booking service.

2) The non-transitory computer-readable medium of claim 1, further comprising:
instructions for allowing the first customer to transmit a counterbid to the electronic offer of the second customer.

3) The non-transitory computer-readable medium of claim 1, further comprising:
instructions for allowing the first customer to transmit a counterbid to the electronic offer of the second customer;
instructions for allowing the second customer to transmit a counterbid to the counterbid of the first customer.

4) The non-transitory computer-readable medium of claim 1, further comprising:
instructions for allowing the first customer to transmit a counterbid to the electronic offer of the second customer;
instructions for allowing the second customer to transmit a counterbid to the counterbid of the first customer;
instructions for allowing the first customer to accept the counterbid of the second customer.

5) The non-transitory computer-readable medium of claim 1, wherein the service provider is a hair cutting professional.

6) The non-transitory computer-readable medium of claim 1, wherein the amount of the electronic offer is entered by the second customer.

7) The non-transitory computer-readable medium of claim 1, wherein the amount of the electronic offer is a fixed amount.

8) The non-transitory computer-readable medium of claim 1, further comprising instructions for transmitting the electronic offer over the Internet.

9) The non-transitory computer-readable medium of claim 1, further comprising instructions for sending the electronic offer peer-to-peer from the second customer to the first customer.

10) The non-transitory computer-readable medium of claim 1, further comprising instructions for sending the electronic offer from the second customer to the first customer through a centralized server.

11) A non-transitory computer-readable medium containing instructions for swapping an electronic appointment from a first customer to a second customer, the non-transitory computer-readable medium comprising:
instructions for displaying available appointment times for one or more service providers;
instructions for receiving a request to book an appointment with a service provider;
instructions for, in response to receiving a request to book an appointment, booking an appointment between a first customer and a first service provider using an electronic booking service;
instructions for receiving a request from a customer to perform a swap of a currently reserved appointment of a service provider;
instructions for transmitting an electronic offer from a second customer to the first customer to perform a swap of the appointment of the first customer, the electronic offer including an offer of payment;
instructions for, when the first customer rejects the electronic offer, not transferring the appointment from the first customer to the second customer;
instructions for, when the first customer accepts the electronic offer, transferring the appointment from the first customer to the second customer;
instructions for accepting payment from the second customer;
instructions for transmitting a first portion of the accepted payment from the second customer to the first customer;
instructions for transmitting a second portion of the accepted payment from the second customer to the service provider;
instructions for transmitting a third portion of the accepted payment from the second customer to a provider of the electronic booking service.

12) The non-transitory computer-readable medium of claim 11, further comprising:
instructions for allowing the first customer to transmit a counterbid to the electronic offer of the second customer.

13) The non-transitory computer-readable medium of claim 11, further comprising:
instructions for allowing the first customer to transmit a counterbid to the electronic offer of the second customer;
instructions for allowing the second customer to transmit a counterbid to the counterbid of the first customer.

14) The non-transitory computer-readable medium of claim 11, further comprising:
instructions for allowing the first customer to transmit a counterbid to the electronic offer of the second customer;
instructions for allowing the second customer to transmit a counterbid to the counterbid of the first customer;
instructions for allowing the first customer to accept the counterbid of the second customer.

15) The non-transitory computer-readable medium of claim 11, wherein the service provider is a hair cutting professional.

16) The non-transitory computer-readable medium of claim 11, wherein the amount of the electronic offer is entered by the second customer.

17) The non-transitory computer-readable medium of claim 11, wherein the amount of the electronic offer is a fixed amount.

18) The non-transitory computer-readable medium of claim 11, further comprising instructions for transmitting the electronic offer over the Internet.

19) The non-transitory computer-readable medium of claim 11, further comprising instructions for sending the electronic offer peer-to-peer from the second customer to the first customer.

20) The non-transitory computer-readable medium of claim 11, further comprising instructions for sending the electronic offer from the second customer to the first customer through a centralized server.
